(19) United States
(12) Patent Application Publication
(10) Pub. No.: US 2019/0262887 A1
(43) Pub. Date: Aug. 29, 2019

(54) METHOD FOR MANUFACTURING TAILORED BLANK PRESS FORMED PRODUCT

(71) Applicant: Topre Corporation, Tokyo (JP)

(72) Inventors: Shogen Hirami, Sagamihara (JP); Minoru Fujikawa, Sagamihara (JP)

(21) Appl. No.: 16/283,438

(22) Filed: Feb. 22, 2019

(30) Foreign Application Priority Data
Feb. 26, 2018 (JP) 2018-031856

(51) Int. Cl. B21D 35/00; B21D 22/22; B23K 9/007

(52) U.S. Cl. CPC B21D 35/006; B23K 2101/185; B23K 9/007; B21D 22/22

(57) ABSTRACT

A method for manufacturing a tailored blank press formed product includes a tailor welding step in which a first steel plate and a second steel plate are abutted against each other and welded together at side surfaces thereof to form a blank; a shearing step of shearing the blank or a first intermediate product, which is a processed blank, along a line that crosses a welding line formed in the tailor welding step; and an electric heating step of electrically heating a welded-and-sheared portion of a sheared section of the blank or the first intermediate product, the welded-and-sheared portion being welded in the tailor welding step.

### CROSS-REFERENCE TO RELATED APPLICATIONS

The present application claims priority from Japanese Patent Application No. 2018-031856 filed Feb. 26, 2018, the contents of which are hereby incorporated by reference into this application.

### BACKGROUND

### 1. Field of the Invention

The present invention relates to a method for manufacturing a tailored blank press formed product, and more particularly to a technology for preventing delayed fractures.

### 2. Description of the Related Art

When two steel plates are tailor welded together and then a weld bead is sheared, the welded portion of the sheared section may have lattice defects in the metal, and this may lead to delayed fractures. FIG. 8 illustrates delayed fractures formed in a welded portion of a sheared section. The delayed fractures may be prevented by performing laser cutting. However, laser cutting requires a larger facility and leads to higher running cost.

Japanese Unexamined Patent Application Publication No. 2004-58082 describes a method for press forming a connected board obtained by integrating boards together by tailor welding. The connected board is heated, and press formed by using a pressing die at a relatively low temperature to prevent a molding failure. However, even when the method according to Japanese Unexamined Patent Application Publication No. 2004-58082 is used, the occurrence of lattice defects in the sheared section cannot be eliminated, and delayed fractures cannot be prevented.

As described above, according to a method for manufacturing a tailored blank press formed product of the related art, it is difficult to shear a weld bead without causing delayed fractures in the welded portion of the sheared section.

### SUMMARY OF THE INVENTION

The present invention has been made to solve the above-described problem, and an object of the present invention is to provide a method for manufacturing a tailored blank press formed product by which delayed fractures in the welded portion of the sheared section can be prevented.

To achieve the above-described object, a method for manufacturing a tailored blank press formed product according to the present invention includes a welding step in which two steel plates are abutted against each other and welded together at side surfaces of the steel plates to form a blank; a shearing step of shearing the blank or a processed blank along a line that crosses a welding line formed in the welding step; and an electric heating step of electrically heating a welded-and-sheared portion of a sheared section of the blank or the processed blank, the welded-and-sheared portion being welded in the welding step.

According to the present invention, after the blank formed by tailor welding or the processed blank is subjected to the shearing process, the welded-and-sheared portion, which is the welded portion of the sheared section, is electrically heated by applying a current thereto. Therefore, lattice defects formed in the welded-and-sheared portion can be resolved, and delayed fractures can be prevented as a result.

### BRIEF DESCRIPTION OF THE DRAWINGS

FIG. 1 is a flowchart illustrating the processing steps of a method for manufacturing a tailored blank press formed product according to an embodiment of the present invention;

FIGS. 2A and 2B illustrate the manner in which a blank is formed by welding two steel plates together by tailor welding;

FIG. 3 illustrates the manner in which the blank is press formed into a first intermediate product;

FIG. 4 illustrates the manner in which the first intermediate product is sheared to form a second intermediate product;

FIG. 5 illustrates welded portions included in a sheared section of the second intermediate product;

FIGS. 6A and 6B are diagrams illustrating a welded portion of the second intermediate product, where FIG. 6A illustrates a welded-and-sheared portion and FIG. 6B illustrates the manner in which the second intermediate product is clamped between a pair of electrodes;

FIG. 7 illustrates the positional relationship between the welded portion of the second intermediate product and the position of energization by the electrodes; and

FIG. 8 illustrates delayed fractures formed in a welded-and-sheared portion.

### DETAILED DESCRIPTION

A method for manufacturing a tailored blank press formed product according to an embodiment of the present invention will now be described with reference to the drawings. In the present embodiment, it is assumed that, for example, two types of super high tensile steel plates (referred to also as super high tensile materials) made of metal materials having a tensile strength of greater than or equal to 980 MPa are tailor welded together to form a pillar (front pillar, center pillar, etc.), which is a member of an automobile body.

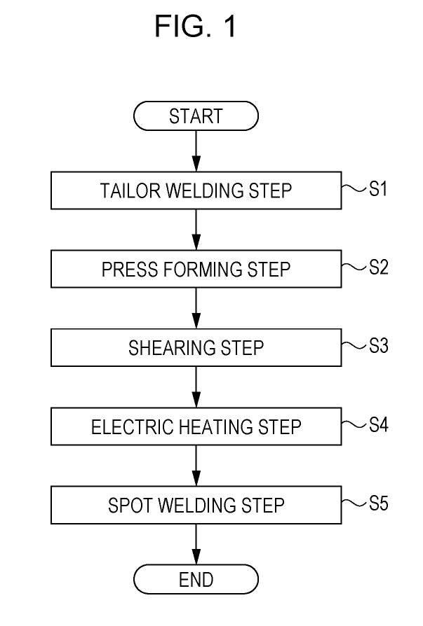

FIG. 1 is a flowchart illustrating the processing steps of the method for manufacturing a tailored blank press formed product according to the embodiment of the present invention. As illustrated in FIG. 1, the manufacturing method includes a tailor welding step S1 (welding step), a press forming step S2, a shearing step S3, an electric heating step S4, and a spot welding step S5.

In the tailor welding step S1, metal plates (steel plates), at least the materials or the thicknesses of which differ from each other, are abutted against each other and welded together at side surfaces thereof. Super high tensile steel plates cut into desired shapes in advance are abutted against each other at side surfaces thereof. Alternatively, a high tensile steel plate and a normal steel plate are abutted against each other at side surfaces thereof. Then, the steel plates are butt-joint welded together by laser welding or plasma welding. This process is called tailor welding.

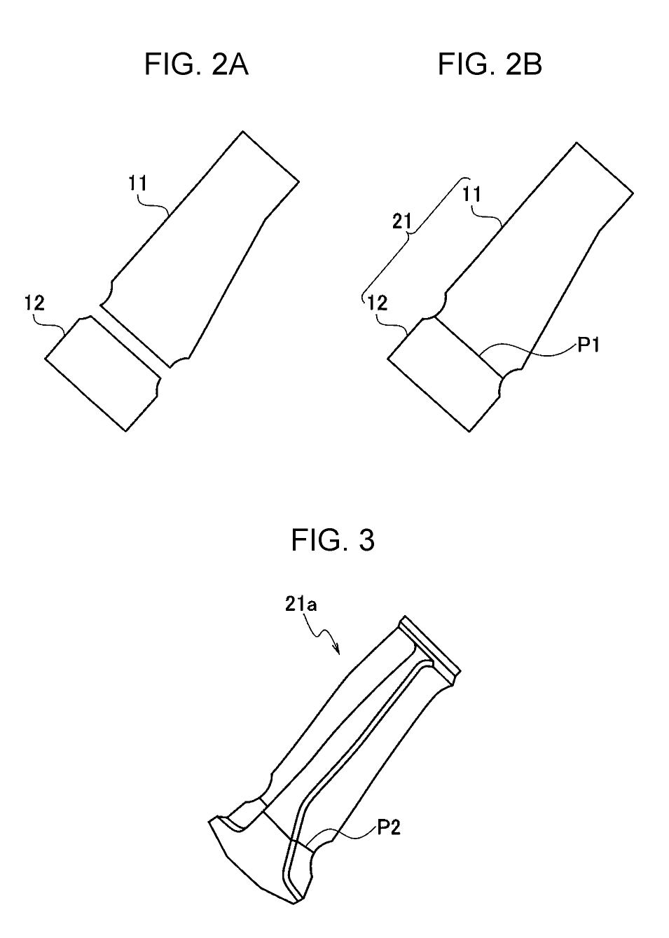

FIGS. 2A and 2B illustrate an example of the tailor welding step performed to form a pillar to be mounted in a vehicle. A first steel plate 11 and a second steel plate 12 are prepared in advance as illustrated in FIG. 2A, and are butt-joint welded along a welding line P1 illustrated in FIG. 2B. As a result, a blank 21 in which the two steel plates 11 and 12 are connected together is obtained. Thus, the first steel plate 11 and the second steel plate 12, at least the materials or the thicknesses of which differ from each other, are tailor welded together so that the first and second steel plates 11 and 12 are integrated together to form the blank 21. Although an example in which two steel plates are tailor welded together is described, three or more steel plates may also be tailor welded together.

In the press forming step S2, the blank 21 formed in the above-described tailor welding step S1 is press formed into a desired shape. FIG. 3 illustrates an example in which a pillar of a vehicle is formed in the press forming step. The blank 21 illustrated in FIG. 2B is press formed into a press formed steel plate illustrated in FIG. 3 (hereinafter referred to as a “first intermediate product 21a”). The welding line P1 is deformed into a welding line P2 in accordance with the shape into which the blank 21 is press formed. Although the press forming step S2 needs to be performed to form the pillar, the effects of the present invention are not affected by this step.

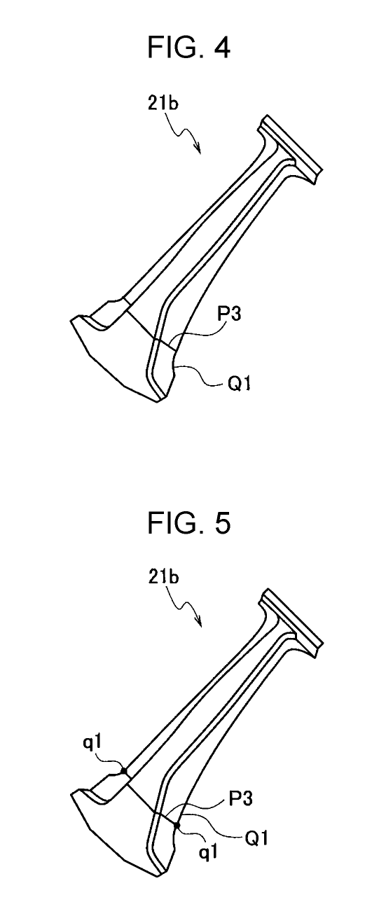

In the shearing step S3, the first intermediate product 21a (processed blank) that has been press formed in the press forming step S2 is subjected to a shearing process for removing unnecessary portions to form the first intermediate product 21a into a desired shape. A hole-forming process may also be performed as necessary. FIG. 4 illustrates an example of the shearing step. The first intermediate product 21a illustrated in FIG. 3 is subjected to the shearing process to obtain a sheared steel plate (hereinafter referred to as a “second intermediate product 21b”). Both ends of the welding line P2 are cut off, and a welding line P3 is obtained as a result.

In the electric heating step S4, a tailor welded portion of a sheared section (hereinafter referred to as a “welded-and-sheared portion”) of the second intermediate product 21b obtained as a result of the shearing process is electrically heated by applying a current thereto. As described below, by electrically heating the welded-and-sheared portion, lattice defects in the welded-and-sheared portion can be resolved, and delayed fractures can be prevented.

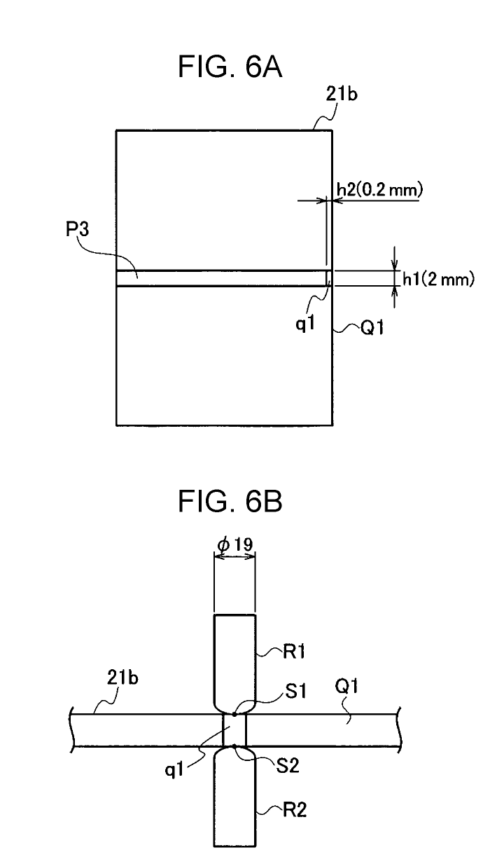

The welded-and-sheared portion can be electrically heated by using electrodes and a welding facility used in the spot welding step S5 performed after the electric heating step S4. For example, when a pillar of a vehicle is formed, the second intermediate product 21b obtained by the shearing process is typically spot welded to another component. In the electric heating step S4, which is performed before the spot welding step S5, the electric heating process is performed by clamping the welded-and-sheared portion of the sheared section with welding electrodes (R1 and R2 in FIG. 6B described below) used in the spot welding process and applying a current between the welding electrodes for a predetermined time. The energizing current, the energizing time, and the pressing force (clamping force) applied to the clamped welded-and-sheared portion will be described below.

FIG. 5 illustrates electrically heated portions of the second intermediate product 21b. Each welded-and-sheared portion q1 of the second intermediate product 21b is electrically heated by bringing the welding electrodes into contact therewith. FIG. 6A is a plan view of a welded portion. Referring to FIG. 6A, a region extending a distance h1 (for example, 2 mm) equal to the width of the welding line P3 and extending inward from a sheared surface Q1 a distance h2 (for example, 0.2 mm) is defined as a welded-and-sheared portion q1. Thus, the welded-and-sheared portion q1 is at an end of the welding line P3. As illustrated in FIG. 6B, which is a side view, at least part of the welded-and-sheared portion q1, which is the area having the dimensions of the plate thickness (for example, 1.2 mm) by the distance h1, is clamped by two electrodes R1 and R2 (above-described electrodes used in spot welding) in the front-back direction of the plate, and a current is applied between the electrodes R1 and R2. At this time, the line that connects end portions S1 and S2 of the welding electrodes R1 and R2, respectively, passes through the welded-and-sheared portion q1. Thus, the welded-and-sheared portion q1 can be electrically heated.

The welded-and-sheared portion q1 will be described in more detail. As described above, the distance h1 is equal to the width of the welding line. This width is generally referred to as a weld bead width. The distance h1 is changed as appropriate in accordance with, for example, the material, the plate thickness, and the welding conditions. The region extending the distance h2 is the region in which the lattice defects are formed in the shearing process. The distance h2 from the sheared surface Q1 is known to be 0.2 mm.

The electrodes R1 and R2 are cylindrical, and preferably have convexly curved end surfaces. For example, as illustrated in 6B, cylindrical electrodes having a diameter of 19 mm and including end portions with a radius of curvature of 150 mm are used. When the electrodes R1 and R2 are convex as described above, a desired clamping force may be applied to the welded-and-sheared portion q1 of the second intermediate product 21b, and the current can be concentrated. Accordingly, the efficiency of the electric heating process can be increased, and the delayed fractures can be more effectively prevented. However, it is not necessary to heat the welded-and-sheared portion q1 until melting, transformation, or glowing of the second intermediate product 21b occurs. Therefore, the energizing current and the energizing time are appropriately controlled as described below. More specifically, the welded-and-sheared portion q1 is preferably heated to a temperature lower than the transformation point of the steel plate. It is also not necessary that both the electrodes R1 and R2 be convex as long as at least one of the electrodes R1 and R2 is convex.

After the electric heating step S4, the spot welding step S5 is performed by using the electrodes R1 and R2. Spot welding is a commonly known process, and detailed description thereof is thus omitted. The spot welding step S5 may instead be performed before the electric heating step S4.

### Description of Test Results

When the above-described tailor welding step S1 and the above-described press forming step S2 are performed and then the steel plate is subjected to the shearing process along a line that crosses the welding line in the shearing step S3, a weld bead formed by tailor welding is naturally sheared. Thus, a welded-and-sheared portion is formed in the sheared section. The lattice defects are formed in the welded-and-sheared portion. The lattice defects cause hydrogen embrittlement, which may lead to the occurrence of the delayed fractures. In the present embodiment, the electric heating process is performed after the shearing step S3 to resolve the lattice defects and prevent the delayed fractures.

As a result of intensive studies, the inventors have found that the region in which the delayed fractures occur under the above-described conditions is the region illustrated in FIG. 6A having the distance h1 of 2 mm and the distance h2 of 0.2 mm. Accordingly, the lattice defects are resolved by electrically heating the steel plate in this region (above-described welded-and-sheared portion q1) by applying a current to this region. The current applied in the electric heating process is preferably concentrated to efficiently increase the temperature.

The results of an actual test will now be described. A super high tensile steel plate having a tensile strength of 980 MPa was prepared as the first steel plate 11 (see FIG. 1), and a super high tensile steel plate having a tensile strength of 1180 MPa was prepared as the second steel plate 12. The steel plates both had a thickness of 1.2 mm. The first steel plate 11 and the second steel plate 12 were butt-welded together by using a laser welder to obtain a steel plate (blank) as a sample.

The sample was sheared in a direction orthogonal to (direction that crosses) the welding line (weld bead) by using a common shearing cutter (shearing step illustrated in FIG. 4). The welded-and-sheared portion (denoted by q1 in FIGS. 6A and 6B), which is the welded portion of the sheared section, was subjected to the electric heating process under various conditions. Table 1 shows the obtained test results

TABLE 1

| | | | | | Energizing | Hydrochloric | | |
|---|---|---|---|---|---|---|---|---|
| | | | | | Position | Acid | | Evaluation |
| | Energizing | Energizing | Pressing | | (Distance | Immersion | | G: Good |
| | Current | Time | Force | Electrode | from End) | Test Result | Occurrence of | F: Fair |
| Condition | (kA) | (msec) | (kN) | Shape | (mm) | (after 96H) | Transformation | P: Poor |
| 1 | 3 | 100 | 2.9 | R150 | 0 | Cracks | | P |
| | | | | | | Formed | | |
| 2 | 3 | 160 | 2.9 | R150 | 0 | Cracks | | P |
| | | | | | | Formed | | |
| 3 | 3 | 200 | 2.9 | R150 | 0 | No Cracks | | G |
| | | | | | | Formed | | |
| 4 | 3 | 300 | 2.9 | R150 | 0 | No Cracks | | G |
| | | | | | | Formed | | |
| 5 | 5 | 100 | 2.9 | R150 | 0 | No Cracks | | G |
| | | | | | | Formed | | |
| 6 | 5 | 160 | 2.9 | R150 | 0 | No Cracks | Transformation | F |
| | | | | | | Formed | Occurred | |
| 7 | 5 | 200 | 2.9 | R150 | 0 | No Cracks | Transformation | F |
| | | | | | | Formed | Occurred | |
| 8 | 7 | 100 | 2.9 | R150 | 0 | No Cracks | Transformation | F |
| | | | | | | Formed | Occurred | |
| 9 | 7 | 160 | 2.9 | R150 | 0 | No Cracks | Transformation | F |
| | | | | | | Formed | Occurred | |
| 10 | 10 | 100 | 2.9 | R150 | 0 | No Cracks | Transformation | F |
| | | | | | | Formed | Occurred | |
| 11 | 5 | 100 | 2.9 | Flat | 0 | Cracks | | P |
| | | | | | | Formed | | |
| 12 | 5 | 160 | 2.9 | Flat | 0 | Cracks | | P |
| | | | | | | Formed | | |
| 13 | 5 | 200 | 2.9 | Flat | 0 | Cracks | | P |
| | | | | | | Formed | | |
| 14 | 5 | 100 | 4.5 | R150 | 0 | No Cracks | | G |
| | | | | | | Formed | | |
| 15 | 5 | 100 | 6.1 | R150 | 0 | No Cracks | | G |
| | | | | | | Formed | | |
| 16 | 5 | 100 | 2.9 | R150 | 2 | No Cracks | | G |
| | | | | | | Formed | | |
| 17 | 5 | 100 | 2.9 | R150 | 4 | Cracks | | P |
| | | | | | | Formed | | |
| 18 | 5 | 100 | 2.9 | R150 | 8 | Cracks | | P |
| | | | | | | Formed | | |

The electric heating process was performed while changing the electric heating conditions including the energizing current, the energizing time, the pressing force applied by the two electrodes, the electrode shape, and the energizing position. After the electric heating process, the second intermediate product 21b was subjected to a hydrochloric acid immersion test. The hydrochloric acid immersion test was performed by immersing the sample in hydrochloric acid of pH 1.0 and determining whether cracks were formed after 96 hours.

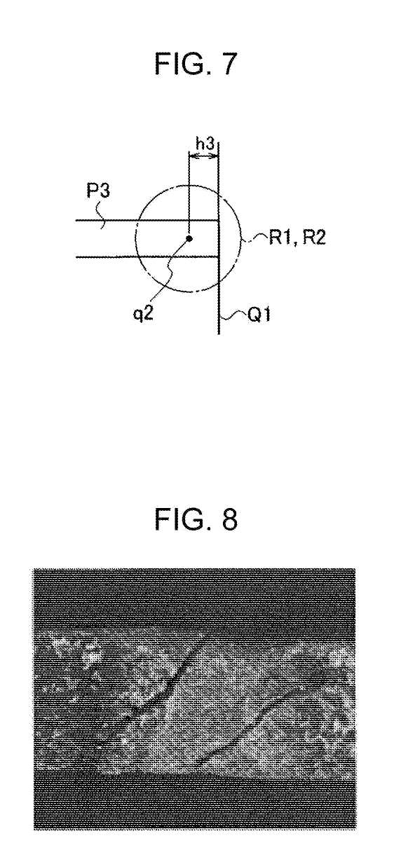

To ensure high mass productivity, electrodes of a commercial spot welder were used as the electrodes R1 and R2. Referring to FIG. 7, the “energizing position” is defined as the distance h3 from the sheared surface Q1 to a point q2 at which the electrodes R1 and R2 are in contact with the second intermediate product 21b. For example, the energizing position of “0” means that the point q2 is on the sheared surface Q1.

The data shown in Table 1 were obtained as the test results. In Table 1, the occurrence of cracks was evaluated and classified into three grades: “Good (G)”, “Fair (F)”, and “Poor (P)”.

In conditions 1 to 10, the pressing force was fixed to 2.9 kN, and the electrode shape was set to R150 (radius of curvature was 150 mm). The test was performed while changing the energizing current in the range of 3 to 10 kA and the energizing time in the range of 100 to 300 msec.

As a result, when the energizing current was 5 kA and the energizing time was 100 msec (condition 5), no cracks were formed and favorable test results were obtained. When the energizing current was reduced to 3 kA (condition 1), cracks were formed and the evaluation result was “Poor”. When the energizing time was increased to 200 to 300 msec (conditions 3 and 4), no cracks were formed and the evaluation result was “Good”.

When condition 5 was changed by increasing the energizing time to 160 to 200 msec (conditions 6 and 7), no cracks were formed but transformation of the steel plate occurred. Also when the energizing current was increased to 7 to 10 kA (conditions 8 to 10), no cracks were formed but transformation of the steel plate occurred. Thus, it was found that favorable results can be obtained by setting the energizing current to 5 kA and the energizing time to 100 msec, or by setting the energizing current to 3 kA and the energizing time to 200 to 300 msec.

The above-described test results show that when the amount of heat applied, which is determined by the energizing current and the energizing time, is insufficient, the lattice defects cannot be completely resolved and the delayed fractures occur. In addition, when the amount of heat applied is excessive and the temperature reaches 723° C., glowing of the steel plate occurs and the crystal structure changes. Thus, so-called transformation of the steel plate occurs. In such a case, although no delayed fractures occur, the surface roughness increases and the appearance of the steel plate becomes less attractive.

In conditions 11 to 13, the end portions of the two electrodes R1 and R2 had a flat (planar) shape, the energizing current was fixed to 5 kA, and the energizing time was changed in the range of 100 to 200 msec. As a result, cracks were formed in each case. This is probably because when the end portions of the electrodes are flat, the contact area between each electrode and the steel plate is increased, and the current is not concentrated, which leads to an increase in the heating area. Accordingly, the lattice defects cannot be resolved and the risk that the delayed fractures will occur increases. These results show that the current can be concentrated when the end portions of the two electrodes R1 and R2 have a convex surface, preferably a curved surface having a radius of curvature of 150 mm. In such a case, the current can be concentrated, and only the welded portion can be effectively electrically heated. As a result, the delayed fractures can be prevented.

When the pressing force applied by the electrodes was increased to 4.5 kN and 6.1 kN (conditions 14 and 15), no cracks were formed and the evaluation result was “Good”. This shows that the pressing force does not greatly affect the results as long as the two electrodes R1 and R2 that clamp the steel plate are in electrical contact with the steel plate. In other words, it is sufficient if the pressing force is strong enough to allow the current to flow. However, when the pressing force applied by the electrodes is so strong as to leave pressure marks on the steel plate (to cause plastic deformation of the material of the steel plate), the contact area between each electrode and the steel plate is increased and concentration of the current is reduced. As a result, the effect of the electric heating process is reduced and there is a risk that the delayed fractures will occur. Therefore, the pressing force needs to have an upper limit to prevent plastic deformation of the material of the steel plate.

In conditions 16 to 18, the position at which the electrodes were placed (distance h3 in FIG. 7) was shifted inward from the end on the sheared surface in the range of 2 to 8 mm. When h3=2 mm (condition 16), no cracks were formed. When h3=4 to 8 mm (conditions 17 and 18), cracks were formed.

When the electrodes R1 and R2 are placed at locations separated from the sheared surface Q1, the portion having the lattice defects cannot be effectively heated. Therefore, the delayed fractures cannot be prevented. This shows that the electrodes R1 and R2 need to be located such that the distance h3 from the sheared surface is in the range of 0 to 2 mm.

The welded-and-sheared portions formed under the conditions classified as “Good” in the above-described test (conditions 3 to 5 and conditions 14 to 16) were observed by an optical microscope. As a result, no change in crystal structure was found in any of the welded-and-sheared portions.

### Description of Effects

The method for manufacturing a tailored blank press formed product according to the present embodiment has the following effects.

(1) Since the welded-and-sheared portion of the steel plate formed by press forming the tailor welded steel plate and shearing the welded portion is electrically heated, the lattice defects formed in the shearing process can be resolved by being heated, and the delayed fractures can be prevented accordingly. When the shearing process is performed, the lattice defects are formed in the welded-and-sheared portion, which is the tailor welded portion of the sheared section, and the risk that the delayed fractures will occur increases. However, since the electric heating step is performed, the delayed fractures can be prevented.

(2) The electric heating process is performed by using the electrodes R1 and R2 used in the spot welding step S5 performed during manufacture of the tailored blank press formed product. Therefore, the electric heating process can be performed without using special devices or components, and replacement of the steel plate, for example, is not necessary. Thus, the electric heating step S4 can be performed by an extremely simple operation.

(3) At least one of the pair of electrodes used in the electric heating process has a convex end portion. Therefore, the contact area between the steel plate and the electrodes can be reduced. Accordingly, the density of the current that flows through the steel plate can be increased, and the welded-and-sheared portion q1 can be heated by concentrating the current at the welded-and-sheared portion q1. As a result, the lattice defects formed in the welded-and-sheared portion can be more reliably resolved, and the delayed fractures can be prevented accordingly.

(4) The line that connects the end portions of the pair of electrodes R1 and R2 used in the electric heating process crosses the welded-and-sheared portion q1. Therefore, the welded-and-sheared portion q1 can be reliably electrically heated by causing the current to flow therethrough, and the delayed fractures can be prevented accordingly.

(5) The pressing force applied by the electrodes is set so as to be less than the force that causes plastic deformation of the steel plate. Therefore, the current density can be prevented from being reduced as a result of an increase in the contact area between the steel plate and the electrodes due to, for example, pressure marks formed on the steel plate.

(6) The temperature to which the welded-and-sheared portion q1 is heated in the electric heating process is set so as to be less than or equal to the temperature (for example, 723° C.) at which the crystal structure of the material of the steel plate changes. Therefore, so-called transformation, which occurs when the amount of heat applied to the steel plate is excessive, can be prevented.

In the above-described embodiment, as illustrated in FIG. 1, the press forming step S2 is performed after the tailor welding step S1, and the spot welding step S5 is performed after the electric heating step S4. However, it is not necessary that the press forming step S2 and the spot welding step S5 be performed. In other words, the effects of the present invention can be obtained by performing the tailor welding step S1, the shearing step S3, and the electric heating step S4.

In addition, although the spot welding step S5 is performed after the electric heating step S4 in the above-described embodiment, the spot welding step S5 may instead be performed before performing the electric heating step S4.

In addition, although the electric heating step S4 is performed by using the electrodes and the facility used in the spot welding step S5, a dedicated electric heating facility may instead be used.

Although an embodiment of the present invention is described above, discussions and drawings that form part of this disclosure should not be understood to limit the present invention. Various alternative embodiments, examples, and operation technologies will be apparent to those skilled in the art based on this disclosure.

What is claimed is:

1. A method for manufacturing a tailored blank press formed product, comprising:
a welding step in which two steel plates are abutted against each other and welded together at side surfaces of the two steel plates to form a blank;
a shearing step of shearing the blank or a processed blank along a line that crosses a welding line formed in the welding step; and
an electric heating step of electrically heating a welded-and-sheared portion of a sheared section of the blank or the processed blank, the welded-and-sheared portion being welded in the welding step.

2. The method for manufacturing the tailored blank press formed product according to claim 1, further comprising:
a spot welding step of performing spot welding on a steel product obtained by shearing the blank or the processed blank, the spot welding step being performed before or after the electric heating step,
wherein the electric heating step is performed by using an electrode used in the spot welding step.

3. The method for manufacturing the tailored blank press formed product according to claim 1, wherein in the electric heating step, the welded-and-sheared portion is clamped by a pair of electrodes, at least one of which is a convex electrode, and a current is applied between the pair of electrodes.

4. The method for manufacturing the tailored blank press formed product according to claim 3, wherein the pair of electrodes are both convex electrodes, and a line that connects end portions of the convex electrodes crosses the welded-and-sheared portion.

5. The method for manufacturing the tailored blank press formed product according to claim 3, wherein a clamping force applied by the pair of electrodes to the welded-and-sheared portion is less than a force that causes plastic deformation of the two steel plates.

6. The method for manufacturing the tailored blank press formed product according to claim 4, wherein a clamping force applied by the pair of convex electrodes to the welded-and-sheared portion is less than a force that causes plastic deformation of the two steel plates.

7. The method for manufacturing the tailored blank press formed product according to claim 1, wherein in the electric heating step, an energizing current and an energizing time are set so that a temperature is lower than a transformation point of the two steel plates.
